(19) United States
(12) Patent Application Publication
(10) Pub. No.: US 2020/0065768 A1
(43) Pub. Date: Feb. 27, 2020

(54) SYSTEM AND METHOD FOR THE AUTOMATED DELIVERY OF MARKETING EMAILS

(71) Applicant: LIGHTSPEED CLEC, INC., NORTH VENICE, FL (US)

(72) Inventors: ROBERT B. FULLER, ENGLEWOOD, FL (US); ADAM C. BALDWIN, WHITEHOUSE STATION, NJ (US)

(21) Appl. No.: 16/539,309

(22) Filed: Aug. 13, 2019

Related U.S. Application Data
(60) Provisional application No. 62/721,376, filed on Aug. 22, 2018.

(51) Int. Cl. G06Q 10/10; G06F 9/54; G06Q 30/02

(52) U.S. Cl. CPC G06Q 10/107; G06Q 30/0201; G06F 9/546

(57) ABSTRACT

A system and method for generating and sending marketing emails. The marketing emails are generated at an API server, where the emails promote a product and/or service, and where the API server is owned and/or controlled by a marketing firm. A user of a computer owned by a sales company logs onto the API server, where the computer operates through a company server, and where the API server formats the marketing emails to include information identifying the sales company. The user of the computer requests that the emails be sent from the API server to the computer, and the emails are sent from the computer to a potential customer using the company server. The request for the emails can be made by pulling or pushing or be manually requested by the user, and the emails can be sent from the computer to the customer automatically or manually by the user.

### CROSS-REFERENCE TO RELATED APPLICATIONS

This application claims the benefit of the filing date of provisional patent application Ser. No. 62/721,376, titled, System and Method for the Automated Delivery of Marketing Emails, filed Aug. 22, 2018.

### BACKGROUND

### Field

This disclosure relates generally to a system and method for sending or delivering emails and, more particularly, to a system and method for the automated delivery of emails, such as marketing emails, to a suitable recipient, such as a customer or potential customer of a sales company, where the emails are generated by a marketing firm through the firm's server, transferred to a representative of the company and then sent to the customer through the company's server.

### Discussion of the Related Art

Marketing is employed to create, keep and satisfy customers for the sale of a product or service, and is generally quite important for business management to improve a company's sales. Marketing generally includes product development, market research, product distribution, sales strategy, public relations and customer support. Advertising is generally an effective marketing tool and comes in many forms, such as television commercials, print advertisements, billboards, etc. Producing and sending emails to potential or existing customers for introducing, describing and promoting a product or service can also be an effective marketing tool. Algorithms, software and processes have been developed to automatically generate and send out marketing emails and have been shown to be effective. Those marketing emails may be follow-up emails to potential customer leads that are generated and sent based on certain input criteria.

Marketing services and firms are available that will provide much of the marketing of a certain product or service for a sales company that sells a product or service, and provide services for following up with potential customer leads, such as by fax, phone call, text message or emails. Those marketing firms may send out automated marketing emails on behalf of the sales company, where the emails are generated and sent automatically at a certain time based on the input data that is used. However, those emails are sent by the marketing firm's email server, where the reply to the email would not go to a representative of the sales company. Thus, these emails are not shown as coming from the server of the company, which may have undesirable consequences. For example, there may be a requirement for security purposes that certain company information only be sent through the company's server.

### SUMMARY

The following discussion discloses and describes a system and method for generating and sending marketing emails. The marketing emails are generated at an application programming interface (API) server, where the emails promote a product or service based on certain input data, and where the API server is owned and controlled by a marketing firm. A user of a computer owned by a sales company that sells certain products and/or services logs onto the API server, where the computer operates through a company server, and where the API server formats the marketing emails to include information identifying the sales company. The user of the computer requests that the emails be sent from the API server to the computer, and the emails are sent from the computer to a potential customer using the company server. The request for the emails can be made automatically at predetermined intervals or can be manually requested by the user, and the emails can be sent from the computer to the customer automatically or manually by the user. The emails can also be pushed from the API sever to the computer.

Additional features of the disclosure will become apparent from the following description and appended claims, taken in conjunction with the accompanying drawings.

### BRIEF DESCRIPTION OF THE DRAWINGS

FIG. 1 is a block diagram of a marketing system that allows marketing emails generated by a third party marketing service that promotes a good or service to be sent to potential customer leads from an email server of the company that provides the good or service; and

FIG. 2 is a flowchart diagram showing a method for allowing the marketing emails to be sent to the potential customer leads from an email server of the company that provides the good or service.

### DETAILED DESCRIPTION OF THE EMBODIMENTS

The following discussion of the embodiments of the disclosure directed to a system and method for sending marketing emails generated by a marketing service to potential customers from a company server is merely exemplary in nature, and is in no way intended to limit the invention or its applications or uses.

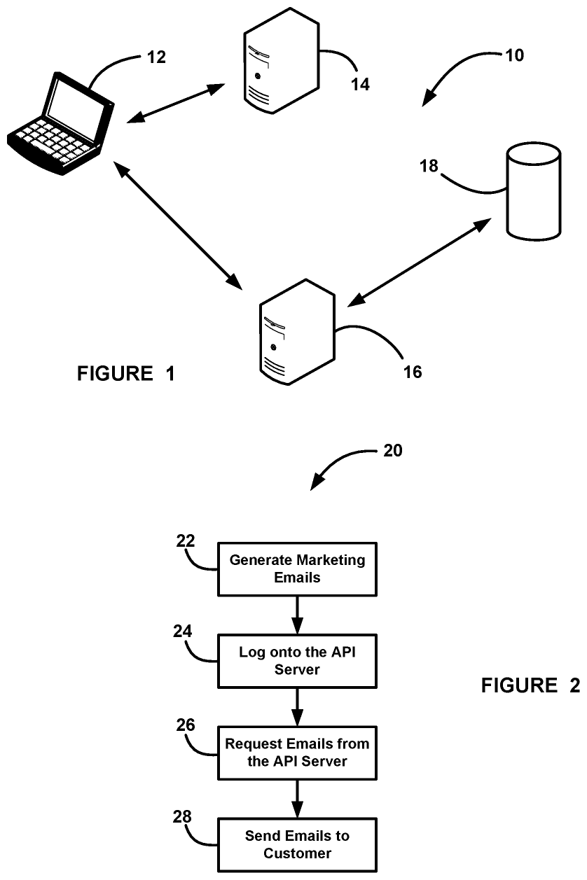

FIG. 1 is a block diagram of a marketing system 10 that allow emails, such as marketing emails, generated by a third party marketing firm, where the emails promote, for example, certain goods and/or services, to be sent from an email server of a company or other entity that provides the goods and/or services. The emails are produced and delivered by any suitable email provider, such as Outlook™, MacMail™, Thunderbird™, web based email clients, etc. The system 10 includes a computer 12 that is owned and/or controlled by the company or other entity and is in communication with a company server 14 that is owned and used by that entity through any suitable network, where the company server 14 would be in communication with other company computers (not shown). The system 10 also includes an application programming interface (API) server 16 that is owned and/or controlled by the marketing firm, where the API server 16 is in communication with the computer 12 over any suitable network connection, and where the computer 12 and the API server 16 can be anywhere in the world. It is noted that defining the server 16 as an API server is meant to generally identify any suitable server connected to the internet to provide data. The API server 16 is able to identify and authenticate the computer 12 and is able to gather the marketing emails that have been previously generated and stored on a database 18 and return them to the computer 12. The emails can be initially set-up by a web page, for example, through a graphical editor, where the email is saved and sent to the API server 16 and saved in the database 18. The computer 12 is equipped with an email client plug-in application so that when a user logs onto the computer 12, a log-in box (not shown) will appear that reminds and allows the user to log onto the API server 16 to obtain the marketing emails that are ready to be sent out to the potential customers. Although the discussion herein refers to the computer 12 logging onto the API server 16, this is merely by example in that a website-based application could be logging onto the API server 16 for the user.

Once the user is logged onto the API server 16, the plug-in application operating on the computer 12 may request the emails from the API server 16 every certain number of minutes or other time interval, or the user of the computer 12 can click a button (not shown) associated with the plug-in application to manually obtain the emails. Also, the user can request that he/she wants to check for emails at certain time intervals, such as 10 second. Alternately, the emails can be can be “pushed” from the API server 16 to the computer 12 without being requested. Upon receiving a request for the emails from the computer 12, the API server 16 will obtain the emails from the database 18 that have been previously generated by the server 16 using the applicable input data for the company, the customer and the product and/or service, where the emails have been formatted to replace contact names, phone numbers, etc. that represent the user and/or the company. The API server 16 sends the emails to the computer 12 and the plug-in application will pull the emails into the email client on the computer 12, where they are automatically sent from the computer 12 to the potential customer or can be generated in an email window for the user to manually send to the potential customer as if they were generated on the company server 14.

The algorithms and processes operating in the API server 16 that generate the marketing emails can be any algorithm or automated process suitable for the purpose described herein. For example, these email generation processes can be any relevant type of customer relationship management (CRM) system that has been developed to manage external company relationships, such as by organizing and storing customer and prospect contact information, identifying sales opportunities, recording service issues, managing marketing campaigns, etc. The CRM system can collect potential customer website, email, telephone numbers, social media data, etc. The company obtains sales leads from any number of sources that are aggregated and imported to the API server 16 and provides a plan for engaging those sources for sales.

FIG. 2 is a flow chart diagram 20 showing a process for allowing marketing emails generated by a third party marketing service that promotes a good and/or service to be sent to potential customer leads from an email server of the company that provides the good and/or service as discussed above in connection with the system 10. The process includes generating the marketing emails at the API server 16 that promotes a product or service based on certain input data at box 22, where the API server 16 is owned and/or controlled by a marketing firm. The process then includes logging onto the API server 16 through the computer 12 owned and/or controlled by a sales company and operating through the company server 14 at box 24, where the API server 16 formats the marketing emails to include information identifying the sales company. The process requests that the emails be sent from the API server 16 to the computer 12 at box 26, and sends the emails from the computer 12 to a potential or existing customer using the company server 14 at box 28.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for generating and sending marketing emails, said method comprising:
generating the marketing emails at an application programming interface (API) server, where the emails promote a product and/or service that have been generated based on certain input data, said API server being owned and/or controlled by a marketing firm;
logging onto the API server through a computer owned and/or controlled by a sales company that sells the product and/or service and operating through a company server, said API server formatting the marketing emails to include information identifying the sales company;
requesting that the marketing emails be sent from the API server to the computer; and
sending the marketing emails from the computer to a potential or existing customer using the company server.

2. The method according to claim 1 wherein requesting that the marketing emails be sent from the API server to the computer automatically occurs at predetermined intervals.

3. The method according to claim 1 wherein requesting that the marketing emails be sent from the API server to the computer occurs when a user of the computer requests the marketing emails from the API server.

4. The method according to claim 1 wherein the marketing emails are pushed from the API server to the computer.

5. The method according to claim 1 wherein sending the marketing emails from the computer occurs automatically when the marketing emails are received by the computer from the API server.

6. The method according to claim 1 wherein sending the marketing emails from the computer occurs manually when a user of the computer sends the marketing emails.

7. The method according to claim 1 wherein the API server retrieves the emails from a database that is owned and/or controlled by the marketing firm.

8. The method according to claim 1 wherein logging onto the API server includes logging onto the API server by the computer itself.

9. The method according to claim 1 wherein logging onto the API server includes logging onto the API server using a website-based application.

10. A method for generating and sending emails, said method comprising:
generating the emails at an application programming interface (API) server, said API server being owned and/or controlled by a first company;
logging onto the API server through a computer owned and/or controlled by a second company, said API server formatting the emails to include information identifying the second company;
requesting that the emails be sent from the API server to the computer; and
sending the emails from the computer to a third party.

11. The method according to claim 10 wherein the emails are marketing emails describing a certain product and/or service, the first company is a marketing firm, the second company sells and/or provides the product and/or service, and the third party is an existing or potential customer of the product and/or service.

12. The method according to claim 10 wherein requesting that the emails be sent from the API server to the computer automatically occurs at predetermined intervals.

13. The method according to claim 10 wherein requesting that the emails be sent from the API server to the computer occurs when a user of the computer requests the emails from the API server.

14. A system for generating and sending marketing emails, said system comprising:
means for generating the marketing emails at an application programming interface (API) server that promote a product and/or service based on certain input data, said API server being owned and/or controlled by a marketing firm;
means for logging onto the API server through a computer owned and/or controlled by a sales company and operating through a company server, said API server formatting the marketing emails to include information identifying the sales company;
means for requesting that the marketing emails be sent from the API server to the computer; and
means for sending the marketing emails from the computer to a potential or existing customer using the company server.

15. The system according to claim 14 wherein the means for requesting that the marketing emails be sent from the API server to the computer causes the marketing emails to be automatically sent at predetermined intervals.

16. The system according to claim 14 wherein the means for requesting that the marketing emails be sent from the API server to the computer causes the marketing emails to be sent when a user of the computer requests the marketing emails from the API server.

17. The system according to claim 14 wherein the marketing emails are pushed from the API server to the computer.

18. The system according to claim 14 wherein the means for sending the marketing emails from the computer sends the marketing emails automatically when the marketing emails are received by the computer from the API server.

19. The system according to claim 14 wherein means for sending the marketing emails from the computer includes manually sending the marketing emails from the computer.

20. The system according to claim 14 wherein the means for logging onto the API server uses a website-based application.
